(19) United States
(12) Patent Application Publication
(10) Pub. No.: US 2008/0166150 A1
(43) Pub. Date: Jul. 10, 2008

(54) Image forming apparatus and method of preventing color misregister therein

(75) Inventor: Yoshihiro Osada, Osaka (JP)

Correspondence Address: SMITH, GAMBRELL & RUSSELL, 1130 CONNECTICUT AVENUE, N.W., SUITE 1130, WASHINGTON, DC, 20036, US

(73) Assignee: KYOCERA MITA CORPORATION

(21) Appl. No.: 12/007,169

(22) Filed: Jan. 7, 2008

(30) Foreign Application Priority Data
Jan. 10, 2007 (JP) 2007-001887

(51) Int. Cl. G03G 15/16; G03G 15/01

(52) U.S. Cl. 399/66; 399/301

(57) ABSTRACT

Provided is an image forming apparatus (1) having polygon mirrors (82) each forming an electrostatic latent image by scanning a photoconductive drum provided in an image forming unit (50a, 50b); and polygon motors (80) each driving and rotating the polygon mirror, the image forming apparatus (1) forming an image by superposing toner images formed on the photoconductive drums one on another, the toner images corresponding to the electrostatic latent images. In the image forming apparatus (1), the polygon mirror (82) of the image forming unit (50a, 50b) is so formed as to have facets whose number is other than a multiple of the number of poles of the polygon motor (80), such that a plurality of stable phase states can be obtained. A driving stop period (T) is provided, such that, if a predetermined amount of phase shift in a subscanning direction is observed between the scanning positions of the polygon mirror (second polygon mirror) of the image forming unit (50a) and the polygon mirror (first polygon mirror) of the image forming unit (50b), the driving of the polygon mirror (first polygon mirror) of the image forming unit (50b) is stopped for a predetermined duration, and is then resumed in another stable phase state.

This application is based on Japanese Patent Application No. 2007-001887 filed on Jan. 10, 2007, the contents of which are hereby incorporated by reference.

### BACKGROUND OF THE INVENTION

1. Field of the Invention

The present invention relates to image forming apparatuses that form an image by superimposing one color on another, and to a method of preventing color misregister therein.

2. Description of Related Art

A conventional image forming apparatus is disclosed, for example, in JP-A-H9-16049. This image forming apparatus has a photoconductive drum with which it performs image forming processes corresponding to a plurality of colors of which a color image is composed. Laser light is scanned across the photoconductive drum by a polygon mirror so as to form an electrostatic latent image thereon, and then a toner image having a color corresponding to the electrostatic latent image thus formed is formed on the surface of the photoconductive drum, and is transferred to a sheet of paper. This process is repeated, such that toner images having different colors are transferred to the sheet of paper with one toner image superimposed on another. In this way, a color image is obtained.

When image formation is performed at the time of restoration from a standby state or at power-on, phase comparison is performed for the polygon mirror relative to a reference signal. If a phase shift is found, the driving of the polygon mirror is stopped. This decreases the speed of the polygon mirror, causing a change in phase thereof. When the polygon mirror becomes in phase with the reference signal, the driving thereof is resumed. This makes it possible to prevent color misregister in the subscanning direction (a direction in which the sheet of paper is conveyed).

However, with the conventional image forming apparatus described above, the polygon mirror starts to slow down when the driving thereof is stopped, and develops a phase lag by degrees after each rotation while being monitored so as not to pull out of synchronization. As a result, the polygon mirror has to keep rotating until it becomes in phase with the reference signal. This results in an increase in a waiting time. In addition, no matter how slight a phase lag is, such a phase lag makes it necessary for the polygon mirror to rotate nearly one-turn once again, making a waiting time further longer. This disadvantageously delays the start of image formation. Furthermore, the phase of the polygon mirror has to be monitored for synchronization with the reference signal. This unfavorably makes control complicated.

### SUMMARY OF THE INVENTION

It is an object of the present invention to provide image forming apparatuses that can prevent color misregister by changing the phase of a polygon mirror quickly with simple control, and to provide a method of preventing color misregister therein.

To achieve the above object, according to one aspect of the present invention, an image forming apparatus is provided with: first and second photoconductive drums; first and second polygon motors; a first polygon mirror that is driven and rotated by the first polygon motor, the first polygon mirror being so formed as to have facets whose number is other than a multiple of the number of poles of the first polygon motor, such that a plurality of stable phase states can be obtained, the first polygon mirror forming an electrostatic latent image by scanning the first photoconductive drum; a second polygon mirror that is driven and rotated by the second polygon motor, the second polygon mirror forming an electrostatic latent image by scanning the second photoconductive drum; an image forming portion for forming an image by transferring toner images formed on the surfaces of the first and second photoconductive drums, the toner images corresponding to the electrostatic latent images, with one toner image superimposed on another; a phase shift detector for detecting whether or not the amount of phase shift in a subscanning direction observed between scanning positions of the first and second polygon mirrors exceeds a predetermined amount; and a controller for controlling the driving of the first polygon motor in such a way that the driving of the first polygon mirror is stopped for a predetermined duration if a phase shift exceeding the predetermined amount is detected by the phase shift detector, and, after the expiration of a driving stop period of the predetermined duration, the driving thereof is resumed in another stable phase state.

With this structure, at the start of image formation, for example, the first polygon mirror is driven and rotated by the first polygon motor, such that the first photoconductive drum is scanned with laser light, and the second polygon mirror is driven and rotated by the second polygon motor, such that the second photoconductive drum is scanned with laser light. At the same time, the phase shift detector detects whether or not the amount of phase shift in the subscanning direction between the scanning positions of the first and second polygon mirrors exceeds a predetermined amount. If the amount of phase shift in the subscanning direction is found to exceed the predetermined amount, the driving of the first polygon mirror is stopped for a predetermined duration corresponding to the amount of phase shift thus detected. For example, suppose that the number of poles of the first polygon motor is six. Then, the rotation thereof can be locked in six positions. In this case, if the number of facets of the first polygon mirror is six, the phase of the first polygon mirror is always the same regardless of where the lock position is. However, suppose that the number of facets of the first polygon mirror is other than a multiple of the number of poles of the first polygon motor, for example, five. Then, the phase of the first polygon mirror varies according to where the lock position is. That is, six stable phase states can be obtained. This makes it possible to change the phase by one-sixth of a dot, for instance, by making the transition to another stable phase state by stopping the driving of the first polygon mirror. When the phase shift in the subscanning direction is corrected, the first and second photoconductive drums are scanned with laser light by the first and second polygon mirrors, respectively, according to the image information. As a result, electrostatic latent images are formed on the first and second photoconductive drums, and toner images corresponding to the electrostatic latent image thus formed are developed. The toner images on the first and second photoconductive drums are transferred to an intermediate transfer member or a sheet of paper with one toner image superimposed on another. In this way, a color image composed of a plurality of colors is formed.

Preferably, in the image forming apparatus structured as described above, the phase shift detector detects a phase shift between the scanning positions of the first and second polygon mirrors by detecting the scanning positions of the first and second polygon mirrors in the subscanning direction when detecting reference positions thereof in the main scanning direction, and by comparing the scanning positions thus detected.

Preferably, in the image forming apparatus structured as described above, the number of facets of the first polygon mirror and the number of poles of the first polygon motor are relatively prime. With this structure, it is possible to change the phase of the first polygon mirror by “1/(the number of poles)” dot in the subscanning direction.

Preferably, in the image forming apparatus structured as describe above, the first and second polygon motors are the same in the number of poles, and the first and second polygon mirrors are the same in the number of facets.

Preferably, in the image forming apparatus structured as described above, a signal for stopping the rotation of the first polygon motor is inputted to the first polygon motor during the driving stop period.

Preferably, in the image forming apparatus structured as described above, a power supply to the first polygon motor is turned off during the driving stop period.

Preferably, in the image forming apparatus structured as described above, the first polygon motor and the first polygon mirror are in a disconnected state during the driving stop period.

Preferably, the image forming apparatus structured as described above is further provided with a storage for storing the predetermined duration corresponding to the amount of phase change of the first polygon mirror. With this structure, if the phase shift in the subscanning direction is found to exceed the predetermined amount, the driving of the first polygon mirror is stopped by setting a driving stop period of the predetermined duration corresponding to the amount of phase shift by referring to the storage.

Preferably, in the image forming apparatus structured as described above, the driving of the first polygon mirror is open-loop controlled during the driving stop period. With this structure, the driving of the first polygon mirror is stopped during the driving stop period without the rotation state thereof being monitored.

The image forming apparatus according to the present invention may be so structured that the first and second polygon motors are the same in the number of poles, the first and second polygon mirrors are the same in the number of facets, and the number of facets of the first polygon mirror and the number of poles of the first polygon motor are relatively prime. Also with this structure, it is possible to input a signal for stopping the rotation of the first polygon motor during the driving stop period, turn off a power supply to the first polygon motor during the driving stop period, and bring the first polygon motor and the first polygon mirror in a disconnected state during the driving stop period. In addition, a storage for storing the predetermined duration corresponding to the amount of phase change of the first polygon mirror may be provided, and the driving of the first polygon mirror may be open-loop controlled during the driving stop period.

According to another aspect of the present invention, a method of preventing color misregister in an image forming apparatus is provided with: a step (#12) of waiting for a predetermined time until the speeds of the first and second polygon motors are stabilized; a step (#13) of detecting scanning positions of the first and second polygon mirrors in a subscanning direction by detecting reference positions thereof in a main scanning direction after the speeds of the first and second polygon motors are stabilized; a step (#14) of comparing phases of the scanning positions of the first and second polygon mirrors in the subscanning direction; a step (#15) of detecting the presence or absence of phase shift by checking whether or not the amount of phase shift exceeds a predetermined amount based on the results of phase comparison; a step (#16) of retrieving from a storage, if the amount of phase shift in the subscanning direction is found to exceed the predetermined amount, a predetermined driving stop period corresponding to the detected amount of phase shift, the predetermined driving stop period during which the driving of the first polygon mirror is stopped; and a step (#17) of stopping the driving of the first polygon mirror during the predetermined driving stop period thus retrieved, and then resuming the driving thereof in another stable phase state. In this method, the steps are repeatedly performed until the phase shift detected in step (#15) becomes acceptable.

With this configuration, it is possible to correct the phase shift between the first and second polygon mirrors only by stopping the driving of the first polygon mirror during the predetermined driving stop period corresponding to the amount of phase shift. This helps simplify the driving control of the polygon mirror. In addition, the phase shift can be corrected while the second polygon mirror is rotating one-turn, making it possible to prevent color misregister, and start image formation without delay.

Preferably, in this method for preventing color misregister, the first and second polygon motors are the same in the number of poles, the first and second polygon mirrors are the same in the number of facets, and the number of facets of the first polygon mirror and the number of poles of the first polygon motor are relatively prime. It is also preferable that the driving of the first polygon mirror be open-loop controlled during the predetermined driving stop period.

### BRIEF DESCRIPTION OF THE DRAWINGS

FIG. 1 is a front view showing an outline of the structure of an image forming apparatus of an embodiment according to the invention;

FIG. 2 is a front view showing the details of the image forming portion of the image forming apparatus of the embodiment according to the invention;

FIG. 3 is a plan view showing the optical scanning unit of the image forming apparatus of the embodiment according to the invention;

FIG. 4 is a diagram conceptually showing a stable phase state of the polygon mirror of the image forming apparatus of the embodiment according to the invention;

FIG. 5 is a block diagram showing the configuration to control the driving of the polygon mirror of the image forming apparatus of the embodiment according to the invention;

FIG. 6 is a diagram showing start-up signals for different polygon motors of the image forming apparatus of the embodiment according to the invention;

FIG. 7 is a flow chart showing the operation to control the driving of the polygon motor of the image forming apparatus of the embodiment according to the invention; and

FIG. 8 is a diagram showing a phase change of the polygon mirror observed when the polygon motor of the image forming apparatus of the embodiment according to the invention is stopped.

### DETAILED DESCRIPTION OF PREFERRED EMBODIMENTS

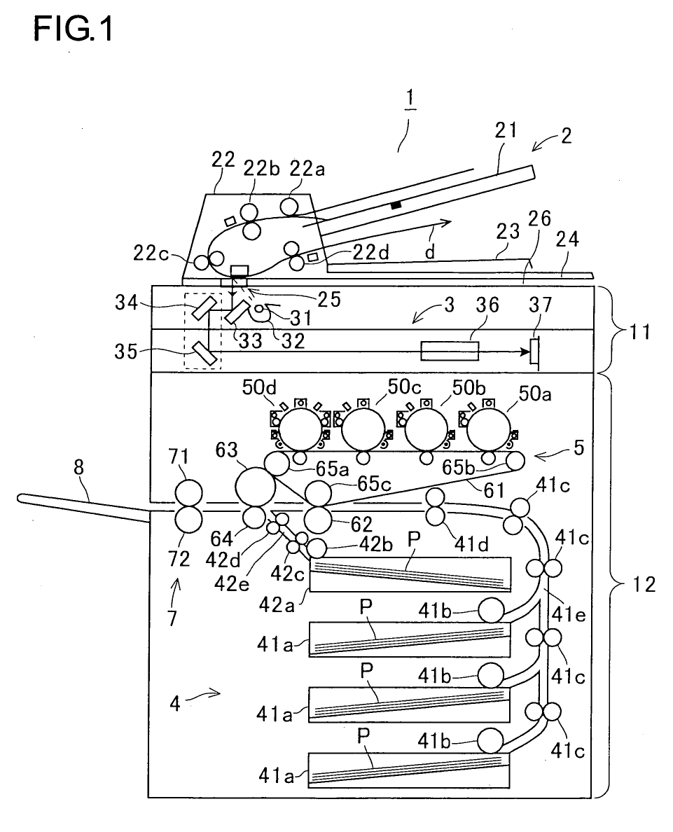

Hereinafter, an embodiment of the present invention will be described with reference to the accompanying drawings. FIG. 1 is a front view showing an outline of the structure of an image forming apparatus of an embodiment. The image forming apparatus 1, which is built as a color copier, has an upper housing 11 and a lower housing 12. A document conveying portion 2 for conveying an original document is placed on the upper housing 11, and is hinged at the side edge thereof (at the edge thereof facing away from the viewer facing FIG. 1) in such a way that the upper housing 11 is opened and closed with the document conveying portion 2.

The document conveying portion 2 includes a document feed tray 21, a document conveying portion main body 22, a document ejection tray 23, and a document cover 24. On the document feed tray 21, the original document is placed. The document conveying portion main body 22 conveys the original document fed from the document feed tray 21 for reading it. The document ejection tray 23 holds the original document ejected from the document conveying portion main body 22. The document conveying portion 2 is opened, such that the original document is placed on a document setting plate 26 provided on the upper housing 11, and is then closed in such a way that the document cover 24 presses the original document.

In the document conveying portion main body 22, there are provided a pickup roller 22a and conveying rollers 22b, 22c, and 22d in this order from the upstream side along a direction d in which the original document is conveyed. The original document is picked up from the document feed tray 21 with the pickup roller 22a, and is then conveyed with the conveying rollers 22b, 22c, and 22d.

Between the conveying rollers 22c and 22d, an image reader 25 is provided. The image reader 25 keeps the original document fed from the document feed tray 21 in a predetermined position, such that an image is read therefrom by an exposure portion 3 provided in the upper housing 11.

The exposure portion 3 includes an exposure lamp 31, a reflecting plate 32, first, second, and third mirrors 33, 34, and 35, a condenser lens 36, and an image sensor 37. The exposure lamp 31 emits light. The light thus emitted is reflected from the reflecting plate 32 and is then shone onto the image reader 25. The light reflected from the original document in the image reader 25 is, after being reflected from the first to third mirrors 33 to 35, focused by the condenser lens 36 onto the image sensor 37 built with a CCD or the like. In this way, the image of the original document fed from the document feed tray 21 is read therefrom.

The exposure lamp 31, the reflecting plate 32, and the first mirror 33 move in unison rightward in FIG. 1, thereby scanning the original document placed on the document setting plate 26. As a result, the light reflected from the original document placed on the document setting plate 26 is focused onto the image sensor 37, whereby the image of the original document is read therefrom.

The lower housing 12 has, inside, a paper feeder 4, an image forming portion 5, and a fusing device 7, and outside, an ejection tray 8. The paper feeder 4, which is located in a lower part of the lower housing 12, includes a paper feed cassette 42a and a plurality of paper feed cassettes 41a, all of which hold a sheet of paper P.

The sheet of paper P held by the paper feed cassettes 41a and 42a is conveyed over paper conveying paths 41e and 42e. The paper conveying path 42e is branched off from the paper conveying path 41e. The sheet of paper P fed from the paper feed cassette 42a is first conveyed over the paper conveying path 42e, and is then conveyed over the paper conveying path 41e. The sheet of paper P conveyed over the paper conveying path 41e is eventually ejected into the ejection tray 8 through an ejection port of the paper conveying path 41e.

The paper conveying path 41e is branched off into as many paths as the number of paper feed cassettes 41a, and the resultant branched paths each have a pickup roller 41b and a conveying roller 41c. After the branched paper conveying paths 41e join into one, a conveying roller 41d is provided somewhere along it. The paper conveying path 42e has a pickup roller 42b and conveying rollers 42c and 42d.

The sheet of paper P is picked up from the paper feed cassette 41a with the pickup roller 41b, and is then conveyed with the conveying rollers 41c and 41d. Also, the sheet of paper P is picked up from the paper feed cassette 42a with the pickup roller 42b, and is then conveyed with the conveying rollers 42c and 42d.

The image forming portion 5 is located above the paper conveying path 41e. The image forming portion 5 forms four toner images having different colors, namely yellow, magenta, cyan, and black, on the sheet of paper P conveyed over the paper conveying paths 41e and 42e in such a way that one image is superimposed on another. This embodiment deals with a case in which four toner images having different colors are transferred to the sheet of paper. However, this structure can be adopted so long as two or more colors are used. The image forming portion 5 is followed by the fusing device 7. The fusing device 7 applies heat to the toner images formed on the sheet of paper P by the image forming portion 5, and fuses them thereto.

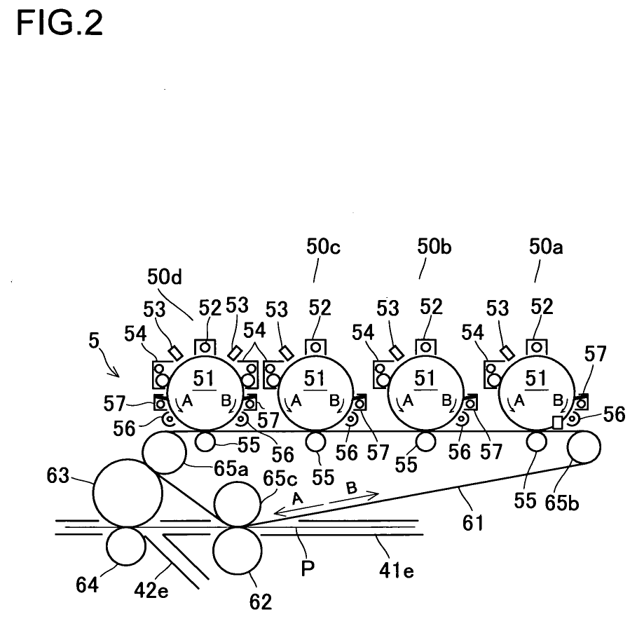

FIG. 2 is a front view showing the details of the image forming portion 5. The image forming portion 5 includes image forming units 50a to 50d, intermediate transfer members 61 and 63, transferring devices 55, 62, and 64, and a meandering detector (not shown) that checks the intermediate transfer member 61 for meandering. The intermediate transfer member 61 is provided in the form of an endless belt. The intermediate transfer belt 61 is stretched around the supporting rollers 65a, 65b, and 65c so as to take the form of a scalene triangle, and is made to rotate. The intermediate transfer member 63 is provided in the form of a rotating drum that is located so as to face the supporting roller 65a with the intermediate transfer member 61 placed between them.

A plurality of transferring devices 55 are provided one for each of photoconductive drums 51, which will be described later. The transferring devices 55 are each provided in such a way as to face a corresponding one of the photoconductive drums 51 with the intermediate transfer member 61 placed between them. A voltage that is opposite in polarity to the toner changed on the surface of the photoconductive drum 51 is applied to the transferring device 55. The transferring device 62 is located so as to face the supporting roller 65c with the sheet of paper P conveyed over the paper conveying path 41e and the intermediate transfer member 61 placed between them. A voltage that is opposite in polarity to the toner charged on the surface of the intermediate transfer member 61 is applied to the transferring device 62.

The transferring device 64 is provided in a stage following a branching point at which the paper conveying path 42e is branched off from the paper conveying path 41e. The transferring device 64 is located so as to face the intermediate transfer member 63 with the sheet of paper P conveyed over the paper conveying path 41e placed between them. A voltage that is opposite in polarity to the toner charged on the surface of the intermediate transfer member 63 is applied to the transferring device 64. Though not illustrated, near the intermediate transfer member 63, there is provided another transferring device to which a voltage that is opposite in polarity to the toner charged on the surface of the intermediate transfer member 61 is applied.

The image forming units 50a to 50d have similar structures, and are arranged in tandem so as to make contact with the intermediate transfer member 61. The image forming units 50a to 50d form yellow, magenta, cyan, and black toner images, respectively. The image forming unit 50d for black is arranged near the intermediate transfer member 63. The arrangement of the image forming units 50a to 50c for yellow, magenta, and cyan may be changed.

The image forming units 50a to 50d each have a photoconductive drum 51. The image forming units 50a to 50c each have, counterclockwise in this figure around the photoconductive drum 51, a charging device 52, an optical scanning unit 53, a developing device 54, a discharging device 56, and a cleaning device 57. Between the developing device 54 and the discharging device 56, the photoconductive drum 51 makes contact with the intermediate transfer member 61.

The photoconductive drum 51 rotates counterclockwise (in the direction indicated by arrow A) in this figure, and is uniformly charged with the charging device 52. As will be described specifically later, the optical scanning unit 53 scans across the charged surface of the photoconductive drum 51 with laser light, and erases charges based on the image information read by the image sensor 37 (see FIG. 1). In this way, an electrostatic latent image is formed on the surface of the photoconductive drum 51.

The developing device 54 supplies toner to the electrostatic latent image formed on the photoconductive drum 51, and thereby develops it to form a toner image. The toner image thus formed is transferred to the intermediate transfer member 61 by the transferring device 55. The discharging device 56 removes the charges on the surface of the photoconductive drum 51. The cleaning device 57 is built with a blade and others, the blade being located to make contact with the photoconductive drum 51, and removes the residual toner that has not been transferred to the intermediate transfer member 61.

As is the case with the image forming units 50a to 50c, the image forming unit 50d for black has, counterclockwise in this figure from the charging device 52 provided on the upper side, the optical scanning unit 53 and the developing device 54, and, beyond the part where it makes contact with the intermediate transfer member 61, the discharging device 56 and the cleaning device 57. This enables the photoconductive drum 51 to transfer the toner image to the intermediate transfer member 61 by rotating counterclockwise (arrow A) in this figure.

Similarly, the image forming unit 50d for black has, clockwise in this figure from the charging device 52, the optical scanning unit 53 and the developing device 54, and, beyond the part where it makes contact with the intermediate transfer member 61, the discharging device 56 and the cleaning device 57. This enables the photoconductive drum 51 to transfer the toner image to the intermediate transfer member 61 by rotating clockwise (arrow B) in this figure.

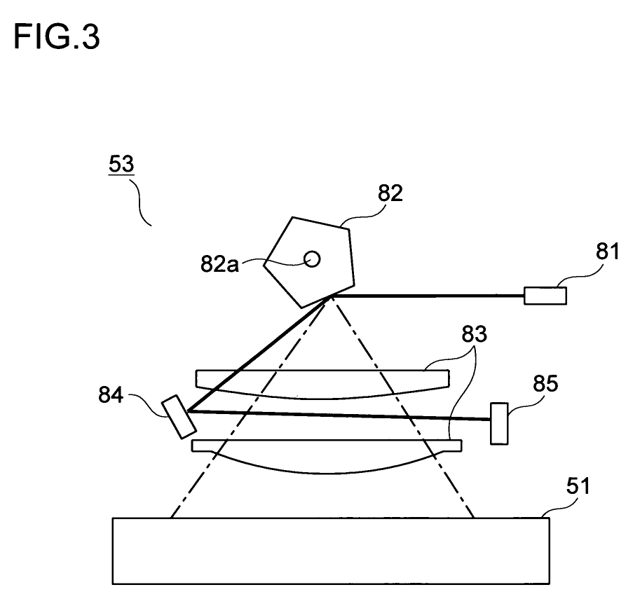

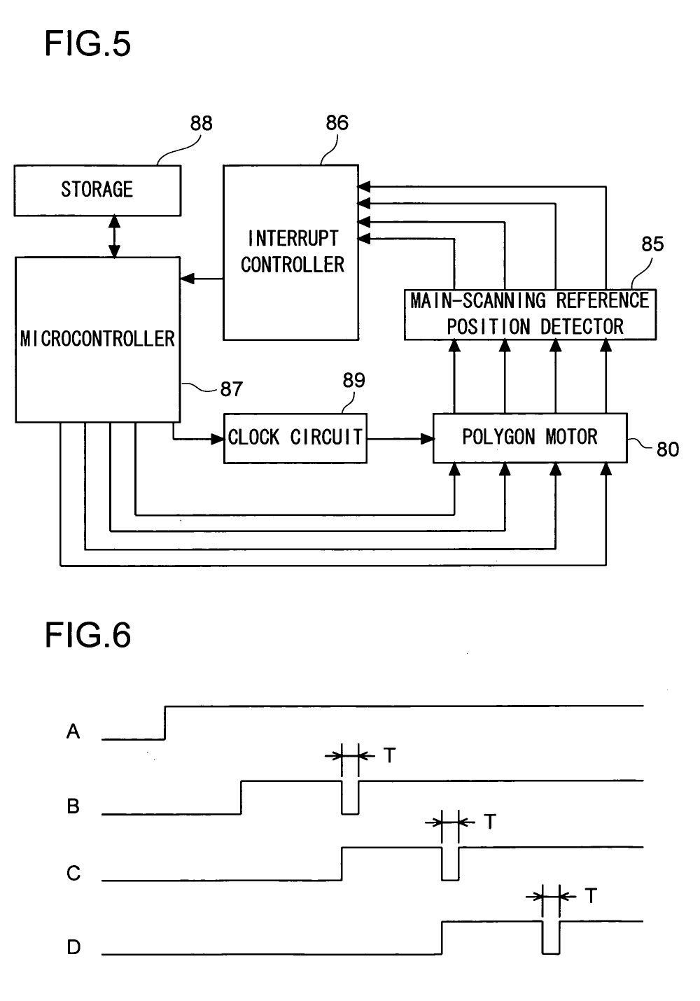

FIG. 3 is a plan view showing the optical scanning unit 53. The optical scanning unit 53 includes a polygon mirror 82, a laser diode 81, an fθ lens 83, a reflecting mirror 84, and a main-scanning reference position detector 85. The polygon mirror 82 is driven and rotated by a polygon motor 80 (see FIG. 5).

The laser diode 81 emits laser light toward the polygon mirror 82. The polygon mirror 82 is so disposed as to face the photoconductive drum 51, and is so formed as to be polygonal, when viewed in cross section normal to a rotation axis 82a thereof. The number of facets of the polygon mirror 82 is other than a multiple of the number of poles of the polygon motor 80.

The phase of the polygon motor 80 is locked and stabilized by using a PLL (phase locked loop). The phase of the polygon motor 80 can be locked in a plurality of positions corresponding to the number of poles. However, the greater the number of poles, the higher the cost; the smaller the number of poles, the lower the stability. It is for this reason that the number of poles is usually set to four to six.

In a case where the number of facets of the polygon mirror 82 is a multiple of the number of poles of the polygon motor 80, the phase of the polygon mirror 82 is always the same regardless of the position where the polygon motor 80 is locked. That is, the polygon mirror 82 has only one stable phase state. On the other hand, in a case where the number of facets of the polygon mirror 82 is other than a multiple of the number of poles of the polygon motor 80, the phase of the polygon mirror 82 varies according to the position where the polygon motor 80 is locked. That is, the polygon mirror 82 has a plurality of stable phase states.

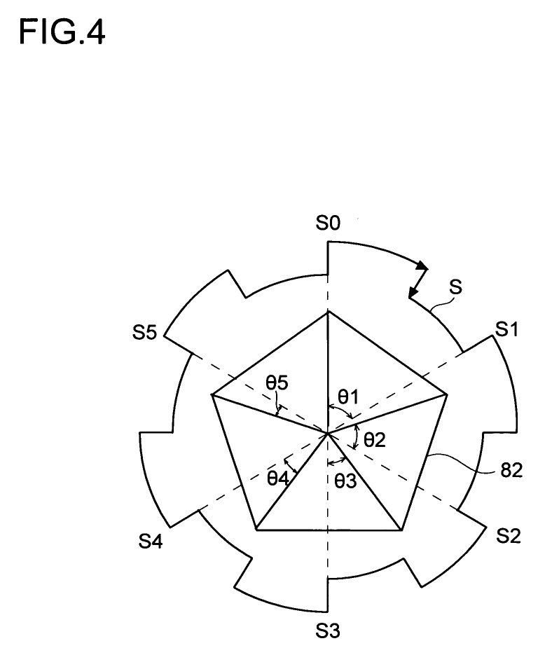

For example, FIG. 4 is a diagram conceptually showing a stable phase state observed when the number of poles p of the polygon motor 80 is six, and the number of facets m of the polygon mirror 82 is five. The polygon motor 80 has a rotor (unillustrated) that is integral with the polygon mirror 82, and a stator (unillustrated) located so as to face the outer circumferential surface of the rotor. The rotor has as many magnets as the number of poles p. When the magnet of the rotor integral with the polygon mirror 82 faces a reference position of the stator of the polygon motor 80 at any one of positions indicated by symbols S0 to S1, the polygon motor 80 is locked, and enters a stable phase state. Clock signals S are then sequentially applied to the stator to rotate the rotor.

Compared with a stable phase state in which the polygon motor 80 is locked with the magnet at position S0 facing the reference position, in a stable phase state in which the polygon motor 80 is locked with the magnet at position S1 facing the reference position, the phase of the polygon mirror 82 is delayed by θ1, namely five-sixths of a line. That is, the phase is advanced in the subscanning direction by one-sixth of a dot. In a stable phase state in which the polygon motor 80 is locked with the magnet at position S2 facing the reference position, the phase of the polygon mirror 82 is delayed by θ2, namely four-sixths of a line. That is, the phase is advanced in the subscanning direction by two-sixths of a dot.

Similarly, in stable phase states in which the rotor is locked with the magnets at positions S3, S4, and S5 facing the reference position, the phase of the polygon mirror 82 is delayed by θ3, θ4, and θ5, namely, three-, two-, and one-sixth of a line, respectively. That is, the phase is advanced in the subscanning direction by three-, four-, and five-sixths of a dot, respectively.

Table 1 shows the number of stable phase states corresponding to the number of poles p of the polygon motor 80 and the number of facets m of the polygon mirror 82, and a phase difference between any given stable phase state and a next stable phase state, the phase difference corresponding to the number of poles p of the polygon motor 80 and the number of facets m of the polygon mirror 82. The absolute value of the phase difference between any given stable phase state and a next stable phase state indicates the accuracy (in dot) of phase adjustment in the subscanning direction.

TABLE 1

| | | Number of | | |
|---|---|---|---|---|
| Number | Number of | Stable Phase | Phase | Accuracy |
| of Poles p | Facets m | States | Difference | (in dot) |
| 6 | 4 | 3 | +⅓ | ⅓ |
| 6 | 5 | 6 | +⅙ | ⅙ |
| 6 | 6 | 1 | 0 | (1) |
| 6 | 7 | 6 | −⅙ | ⅙ |
| 6 | 8 | 3 | −⅓ | ⅓ |
| 6 | 9 | 2 | −½ | ½ |
| 6 | 10 | 3 | +⅓ | ⅓ |

As shown in Table 1, in a case where the number of facets m of the polygon mirror 82 is other than a multiple of the number of poles p of the polygon motor 80, the accuracy of phase adjustment in the subscanning direction is “(the greatest common divisor of the number of poles p and the number of facets m)/(the number of poles p)” dot. That is, the phase can be adjusted with an accuracy of better than 1 dot. In a case where the number of poles p and the number of facets m are relatively prime, the accuracy of phase adjustment in the subscanning direction is “1/(the number of poles p)” dot. This ensures a higher degree of accuracy of phase adjustment.

In FIG. 3, the laser light emitted from the laser diode 81 is reflected from the rotating polygon mirror 82, and is made to scan the surface of the photoconductive drum 51 in the main scanning direction. The polygon mirror 82 scans the photoconductive drum 51 in the subscanning direction as the drum rotates.

The fθ lens 83 converts the light reflected from the polygon mirror 82 into light with uniform velocity, and focuses it onto the photoconductive drum 51. The reflecting mirror 84 is disposed on the side of the fθ lens 83, and is made to reflect the light that has been emitted from the laser diode 81 and reflected from the polygon mirror 82 toward the main-scanning reference position detector 85. The main-scanning reference position detector 85 is composed of a photodiode, a phototransistor, or the like. The main-scanning reference position detector 85 receives the light reflected from the reflecting mirror 84, thereby detects a reference position thereof in the main scanning direction, and at the same time detects the position of light shone onto the photoconductive drum 51 in the subscanning direction based on the incident point of light.

FIG. 5 is a block diagram showing the configuration to control the driving of the polygon mirror 82. The image forming apparatus 1 has a microcontroller 87 that controls different parts of the image forming apparatus 1. The microcontroller 87 transmits a start-up signal or the like to the polygon motors 80 of the image forming units 50a to 50d, thereby controlling the driving thereof.

To the microcontroller 87, a storage 88 and a clock circuit 89 are connected. The storage 88, which is composed of a nonvolatile memory and a volatile memory, stores an operating program, various data, calculation results of the microcontroller 87, and the like. The clock circuit 89 produces a clock signal for the polygon motors 80. The polygon motors 80 are made to rotate with a predetermined period in synchronism with a common clock signal.

Also provided is an interrupt controller 86 that receives an interrupt and makes the microcontroller 87 handle the interrupt. When the reference position is detected by the main-scanning reference position detector 85, the interrupt controller 86 sends a signal to the microcontroller 87. Based on the intervals at which the interrupts are sent, it is possible to detect the rotation speed of the polygon mirror 82 driven by the polygon motor 80. Instead, the interrupt controller 86 may be incorporated in the microcontroller 87.

In the image forming apparatus 1 structured as described above, when an original document is placed on the document feed tray 21 or the document setting plate 26, an image of the original document is read by the image sensor 37 of the exposure portion 3. The image information thus read is sent to the image forming portion 5.

In a case where a color image is formed by the image forming portion 5, the intermediate transfer member 61 is made to rotate in the direction indicated by arrow A shown in FIG. 2 by the driving of the supporting roller 65b. The photoconductive drums 51 of the image forming units 50a to 50d individually rotate in the direction indicated by arrow A shown in FIG. 2. When the photoconductive drum 51 starts rotating, the surface thereof is uniformly charged with the charging device 52.

Next, laser light is shone onto the photoconductive drum 51 from the optical scanning unit 53. FIG. 6 shows start-up signals for the polygon motors 80 of the image forming units 50a to 50d. In this figure, characters A to D correspond to the polygon motors 80 of the image forming units 50a to 50d, respectively. The polygon motors 80 are sequentially started in such a way as to prevent an increase in the maximum current, and are made to rotate at a predetermined clock frequency.

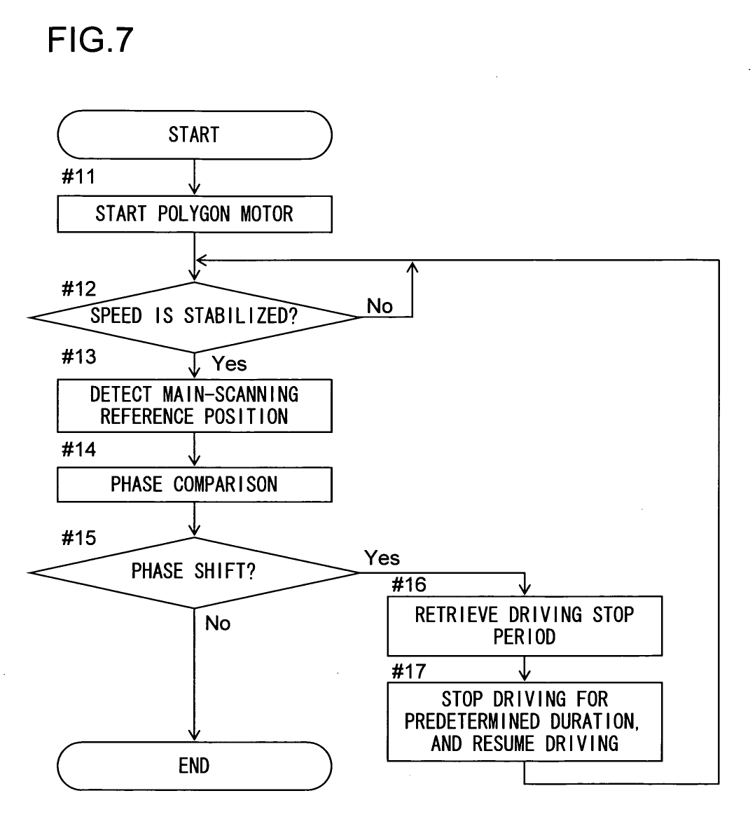

FIG. 7 is a flow chart showing the operation to control the driving of the polygon motor 80 of the image forming unit 50b, showing an example of a method for preventing color misregister in the image forming apparatus of the invention. In this color misregister prevention method, when image formation is performed at the time of restoration from a standby state or at power-on, phase adjustment of the polygon mirror 82 is performed as follows. In step #11, the polygon motor 80 is started. In step #12, there is a wait of a predetermined time until the speed of the polygon motor 80 is stabilized.

After the speed is stabilized, in step #13, the reference positions of laser light in the main scanning direction, the laser light being reflected from the polygon mirrors 82 of the image forming units 50a and 50b, are detected by the main-scanning reference position detectors 85. At the same time, the positions of the laser light reflected from the polygon mirrors 82 in the subscanning direction are detected.

In step #14, the phases of the positions of the laser light in the subscanning direction, the positions being detected by the main-scanning reference position detectors 85 of the image forming units 50a and 50b, are compared with each other. In step #15, it is judged that a phase shift is present if the amount of shift between the phases thus compared exceeds a predetermined amount; it is judged that no phase shift is present if the amount of shift between the phases thus compared is equal to or smaller than a predetermined amount. As described above, a component that performs steps #13, #14, and #15 forms a phase shift detector for detecting whether or not the amount of phase shift in the subscanning direction observed between the scanning positions of a first polygon mirror and a second polygon mirror exceeds a predetermined amount.

If the amount of phase shift in the subscanning direction is found to exceed the predetermined amount, the procedure proceeds to step #16. Here, different durations for which the polygon motor 80 is stopped, the different durations being provided one for each of the different amounts of phase shift in the subscanning direction, are experimentally obtained and stored in the storage 88. In step #16, a duration for which the polygon mirror 80 is stopped, the duration corresponding to the amount of phase shift in the subscanning direction detected in step #15, is retrieved from the storage 88.

In step #17, the polygon motor 80 of the image forming unit 50b is stopped for the duration retrieved in step #16. In this way, a driving stop period T (see FIG. 6) is provided during which the driving of the polygon mirror 82 is stopped for a predetermined duration. After the expiration of the driving stop period T, the driving of the polygon mirror 82 is resumed.

Since the driving stop period T is set by a drive signal given to the polygon motor 80 for stopping the rotation of the polygon mirror 82, it is possible to stop the driving of the polygon motor 82 with ease. Alternatively, the driving stop period T may be set by turning off the power supply to the polygon motor 80. This makes it easy to stop the driving of the polygon mirror 82, and helps save electric power. Instead, the driving stop period T may be set by disconnecting the polygon motor 80 and the polygon mirror 82. That is, the driving of the first polygon motor may be controlled in such a way that the driving of the first polygon mirror is stopped for a predetermined duration if a phase shift exceeding a predetermined amount is detected by the detector, and, after the expiration of a driving stop period of the predetermined duration, the driving thereof is resumed in another stable phase state. A component that controls the polygon motor 80 shown in FIG. 5 forms a controller.

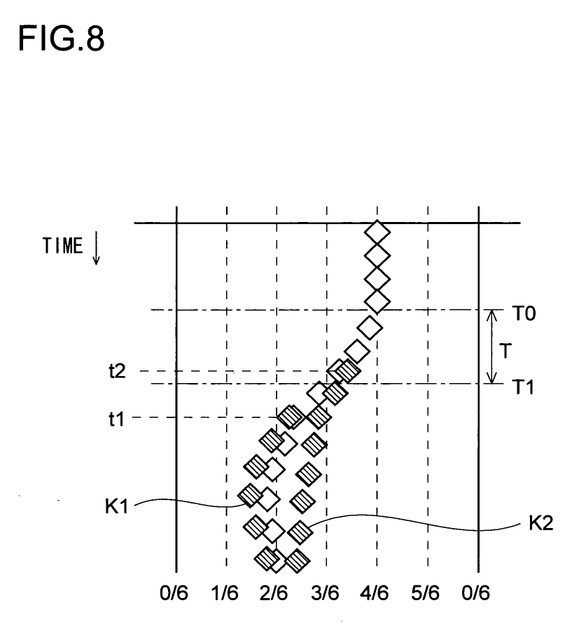

FIG. 8 is a diagram showing a phase change of the polygon mirror 82 observed when the polygon motor 80 is stopped. This example deals with a case in which the number of poles of the polygon motor 80 is six, and the number of facets of the polygon mirror 82 is seven. Suppose that the phase of the polygon mirror 82 is advanced by four-sixths of a line, and adjustment has to be performed in such a way that the phase thereof is advanced by two-sixths of a line. Then, the driving of the polygon motor 80 is stopped at stop time point T0, and is resumed at resumption time point T1.

As a result, the driving of the polygon motor 80 is stopped only during a predetermined driving stop period T, and is resumed after the expiration of the driving stop period T. This decreases the speed of the polygon motor 80, whereby the phase of the polygon mirror 82 is gradually shifted, and is eventually adjusted to a position shifted by two-sixths of a line. In this figure, symbols K1 and K2 indicate the results of phase change obtained by experimentally employing resumption time points t1 and t2, respectively. By doing such an experiment or simulation, an optimum driving stop period T is obtained. The optimum driving stop period T thus obtained is stored in the storage 88. In this case, the data stored in the storage 88 may be modified afterward based on the results obtained by actually changing the phase.

After the driving of the polygon motor 80 is resumed, the procedure goes back to step #12. Thereafter, steps #12 to #17 are repeatedly performed until the phase shift in the subscanning direction becomes acceptable. If it is judged in step #15 that no phase shift is present in the subscanning direction, the procedure is ended. The driving of the polygon motors 80 of the image forming units 50c and 50d is controlled in a similar manner.

When the driving of the polygon motors 80 of the image forming units 50c and 50d is controlled, the phase of the polygon mirror 82 of the image forming unit 50c may be compared with that of the image forming unit 50a or the image forming unit 50b; the phase of the polygon mirror 82 of the image forming unit 50d may be compared with that of the image forming unit 50a, the image forming unit 50b, or the image forming unit 50c.

The charges on an area of the photoconductive drum 51 corresponding to an image area or non-image area to be formed on the sheet of paper P are removed by the laser light shone onto the photoconductive drum 51 from the optical scanning unit 53. As a result, an electrostatic latent image is formed on the surface of the photoconductive drum 51. The electrostatic latent image on the photoconductive drum 51 is supplied with toner from the developing device 54, and is developed to form a toner image.

Further rotation of the photoconductive drum 51 brings the toner image formed thereon to a position facing the transferring device 55. At this point, a voltage that is opposite in polarity to the toner is applied to the transferring device 55. As a result, the toner image formed on the surface of the photoconductive drum 51 is transferred to the intermediate transfer member 61. The electrostatic latent image on the surface of the photoconductive drum 51 is removed by the discharging device 56, and the residual toner that has not been transferred to the intermediate transfer member 61 is removed from the surface of the photoconductive drum 51 by the cleaning device 57.

The toner images formed on the surfaces of the photoconductive drums 51 of the image forming units 50a to 50d are sequentially transferred to the intermediate transfer member 61 with one toner image superimposed on another. As a result, a toner image composed of colors including black is formed.

Further rotation of the intermediate transfer member 61 brings the toner image thus formed to a position facing the transferring device 62. Just as the toner image is brought to that position, the sheet of paper P conveyed over the paper conveying path 41e is located between the intermediate transfer member 61 and the transferring device 62. A voltage that is opposite in polarity to the toner is applied to the transferring device 62, whereby the toner image on the intermediate transfer member 61 is transferred to the sheet of paper P. The residual toner on the intermediate transfer member 61 is removed therefrom by a cleaning device (unillustrated).

The sheet of paper P to which the toner image is transferred is conveyed over the paper conveying path 41e, and is then led into the fusing device 7. In the fusing device 7, the toner image is fused to the sheet of paper P. The sheet of paper P to which the image is fused is conveyed over the paper conveying path 41e, and is then ejected into the ejection tray 8.

In a case where a monochrome image is formed with the image forming portion 5, the intermediate transfer member 61 rotates in the direction indicated by arrow B shown in FIG. 2 by the driving of the supporting roller 65a. In this case, although the photoconductive drums 51 of the image forming units 50a to 50c for yellow, magenta, and cyan rotate in contact with the intermediate transfer member 61 in the direction indicated by arrow B, they perform no image formation.

The photoconductive drum 51 of the image forming unit 50d for black rotates clockwise (in a direction indicated by arrow B) in this figure. A monochrome toner image is formed on the photoconductive drum 51 in the same manner as described above, and is then transferred to the intermediate transfer member 61. When the toner image transferred to the intermediate transfer member 61 is brought to a position facing the intermediate transfer member 63, it is transferred to the intermediate transfer member 63 by an unillustrated transferring device.

Further rotation of the intermediate transfer member 63 brings the toner image transferred to the intermediate transfer member 63 to a position facing the transferring device 64. Just as the toner image is brought to that position, the sheet of paper P conveyed from the paper feed cassette 42a over the paper conveying paths 42e and 41e is located between the intermediate transfer member 63 and the transferring device 64. A voltage that is opposite in polarity to the toner is applied to the transferring device 64, whereby the toner image on the intermediate transfer member 63 is transferred to the sheet of paper P. The residual toner on the intermediate transfer member 63 is removed therefrom by a cleaning device (unillustrated).

The sheet of paper P to which the toner image is transferred is conveyed over the paper conveying path 41e, and is then led into the fusing device 7. In the fusing device 7, the toner image is fused to the sheet of paper P. The sheet of paper P to which the image is fused is conveyed over the paper conveying path 41e, and is then ejected into the ejection tray 8.

As described above, as compared with when a color image is formed, when a monochrome image is formed, a toner image is conveyed over a shorter distance from the photoconductive drum 51 to a point where it is fused to the sheet of paper P. This helps reduce the time that it takes to eject a first image when forming monochrome images.

According to this embodiment, the number of facets m of the polygon mirror 82 (the first polygon mirror) of the image forming unit 50b is other than a multiple of the number of poles p of the polygon motor 80 (the first polygon motor). If a predetermined amount of phase shift in the subscanning direction is observed between the scanning positions of the polygon mirror 82 (the first polygon mirror) of the image forming unit 50b and the polygon mirror 82 (the second polygon mirror) of the image forming unit 50a, the driving of the polygon mirror 82 of the image forming unit 50b is stopped for a predetermined duration, and is then resumed in another stable phase state. This makes it possible to correct a phase shift in the subscanning direction, the phase shift not greater than 1 dot, while the polygon mirror 82 (the second polygon mirror) of the image forming unit 50a is rotating one-turn.

For the image forming units 50c and 50d having a structure similar to that of the image forming unit 50b, it is possible to correct a phase shift in the subscanning direction, the phase shift not greater than 1 dot, while the polygon mirror 82 of the image forming unit 50a is rotating one-turn. This makes it possible to prevent color misregister, and start image formation without delay.

In the image forming units 50b to 50d, the number of facets m of the polygon mirror 82 and the number of poles p of the polygon motor 80 are relatively prime. This makes it possible to correct a phase shift in the subscanning direction with a high degree of accuracy.

For the image forming unit 50a, no restrictions are placed on the number of poles of the polygon motor 80 (the second polygon motor) and the number of facets of the polygon mirror 82 (the second polygon mirror). However, it is preferable that the image forming unit 50a be formed in a similar manner as the image forming units 50b to 50d. This makes it possible to use common parts in these units, and drive the polygon mirrors 82 of the image forming units 50a to 50d with a common clock signal. Using a common clock signal eliminates the need to produce a plurality of clock signals, and thus helps achieve a simple structure.

Since the storage 88 is provided that stores, as a driving stop period T, different durations corresponding to different amounts of phase change of the polygon mirror 82, the different durations for which the polygon motor 80 is stopped, it is possible to easily make the transition to a desired stable phase state by retrieving an appropriate driving stop period from the storage 88.

During the driving stop period T, feedback control for monitoring the rotation of the polygon mirror 82 is not performed; instead, the polygon mirror 82 is open-loop controlled without the rotation state thereof being monitored. This helps simplify the driving control of the polygon mirror 82.

In FIG. 7, the procedure may be ended after step #17 without going back to step #12 if the phase of the polygon mirror 82 can be adjusted to a desired phase with a high degree of accuracy during the first driving stop period T.

This embodiment deals with a case in which the image forming apparatus 1 is built as a color copier; however, the image forming apparatus 1 may be an image forming apparatus of any other type, such as a printer, a facsimile, or the like. That is, the same effects can be achieved in any image forming apparatus that forms a color image by transferring toner images of different colors from the photoconductive drum 51.

As described above, the present invention is directed to an image forming apparatus and a method of preventing color misregister therein. Here, the number of facets of the first polygon mirror is other than a multiple of the number of poles of the first polygon motor. If a phase shift in the subscanning direction is observed between the scanning positions of the first and second polygon mirrors, the driving of the first polygon mirror is stopped for a predetermined duration, and is then resumed in another stable phase state. This makes it possible to correct a phase shift in the subscanning direction, the phase shift not greater than 1 dot, while the second polygon mirror is rotating one-turn. This makes it possible to prevent color misregister, and start image formation without delay. In addition, since there is no need to monitor the rotation state of the first polygon mirror, it is possible to simplify the control.

According to the invention, since the number of facets of the first polygon mirror and the number of poles of the first polygon motor are relatively prime, it is possible to correct a phase shift in the subscanning direction with a high degree of accuracy.

According to the invention, since the first and second polygon motors are the same in the number of poles, and the first and second polygon mirrors are the same in the number of facets, it is possible to use common parts. In addition, it is possible to drive the first and second polygon mirrors with a common clock signal. This eliminates the need to produce a plurality of clock signals, and thus helps simplify the structure.

According to the invention, since a signal for stopping the rotation of the first polygon motor is inputted to the first polygon motor during the driving stop period, it is possible to stop the driving of the first polygon mirror with ease.

According to the invention, since the power supply to the first polygon motor is turned off during the driving stop period, it is possible to stop the driving of the first polygon mirror with ease, and achieve power saving.

According to the invention, since the first polygon motor and the first polygon mirror are in a disconnected state during the driving stop period, it is possible to stop the driving of the first polygon mirror with ease.

According to the invention, a storage is provided that stores different durations corresponding to different amounts of phase change of the first polygon mirror, it is possible to easily make the transition to a desired stable phase state.

According to the invention, since the driving of the first polygon mirror is open-loop controlled during the driving stop period, there is no need to monitor the rotation state of the first polygon mirror. This helps simplify the control.

The invention helps realize image forming apparatuses that can prevent color misregister by changing the phase of a polygon mirror quickly with simple control, and helps realize a method of preventing color misregister therein. Therefore, the invention can be applied to image forming apparatuses that form an image by superimposing one color on another.

What is claimed is:

1. An image forming apparatus, comprising:
first and second photoconductive drums;
first and second polygon motors;
a first polygon mirror that is driven and rotated by the first polygon motor, the first polygon mirror being so formed as to have facets whose number is other than a multiple of a number of poles of the first polygon motor, such that a plurality of stable phase states can be obtained, the first polygon mirror forming an electrostatic latent image by scanning the first photoconductive drum;
a second polygon mirror that is driven and rotated by the second polygon motor, the second polygon mirror forming an electrostatic latent image by scanning the second photoconductive drum;
an image forming portion for forming an image by transferring toner images formed on surfaces of the first and second photoconductive drums, the toner images corresponding to the electrostatic latent images, with one toner image superimposed on another;
a phase shift detector for detecting whether or not an amount of phase shift in a subscanning direction observed between scanning positions of the first and second polygon mirrors exceeds a predetermined amount; and
a controller for controlling a driving of the first polygon motor in such a way that the driving of the first polygon mirror is stopped for a predetermined duration if a phase shift exceeding the predetermined amount is detected by the phase shift detector, and, after an expiration of a driving stop period of the predetermined duration, the driving thereof is resumed in another stable phase state.

2. The image forming apparatus of claim 1, wherein
the phase shift detector detects a phase shift between the scanning positions of the first and second polygon mirrors by detecting the scanning positions of the first and second polygon mirrors in the subscanning direction when detecting reference positions thereof in the main scanning direction, and by comparing the scanning positions thus detected.

3. The image forming apparatus of claim 1, wherein
a number of facets of the first polygon mirror and a number of poles of the first polygon motor are relatively prime.

4. The image forming apparatus of claim 1, wherein
the first and second polygon motors are a same in a number of poles, and the first and second polygon mirrors are a same in a number of facets.

5. The image forming apparatus of claim 1, wherein
a signal for stopping a rotation of the first polygon motor is inputted to the first polygon motor during the driving stop period.

6. The image forming apparatus of claim 1, wherein
a power supply to the first polygon motor is turned off during the driving stop period.

7. The image forming apparatus of claim 1, wherein
the first polygon motor and the first polygon mirror are in a disconnected state during the driving stop period.

8. The image forming apparatus of claim 1, further comprising:
a storage for storing the predetermined duration corresponding to an amount of phase change of the first polygon mirror.

9. The image forming apparatus of claim 1, wherein
the driving of the first polygon mirror is open-loop controlled during the driving stop period.

10. The image forming apparatus of claim 1, wherein
the first and second polygon motors are a same in a number of poles,
the first and second polygon mirrors are a same in a number of facets,
the number of facets of the first polygon mirror and the number of poles of the first polygon motor are relatively prime.

11. The image forming apparatus of claim 10, wherein
a signal for stopping a rotation of the first polygon motor is inputted to the first polygon motor during the driving stop period.

12. The image forming apparatus of claim 11, further comprising:
a storage for storing the predetermined duration corresponding to an amount of phase change of the first polygon mirror,
wherein the driving of the first polygon mirror is open-loop controlled during the driving stop period.

13. The image forming apparatus of claim 10, wherein
a power supply to the first polygon motor is turned off during the driving stop period.

14. The image forming apparatus of claim 13, further comprising:
a storage for storing the predetermined duration corresponding to an amount of phase change of the first polygon mirror,
wherein the driving of the first polygon mirror is open-loop controlled during the driving stop period.

15. The image forming apparatus of claim 10, wherein
the first polygon motor and the first polygon mirror are in a disconnected state during the driving stop period.

16. The image forming apparatus of claim 15, further comprising:
a storage for storing the predetermined duration corresponding to an amount of phase change of the first polygon mirror,
wherein the driving of the first polygon mirror is open-loop controlled during the driving stop period.

17. A method of preventing color misregister in an image forming apparatus,
the image forming apparatus comprising:
first and second photoconductive drums;
first and second polygon motors;
a first polygon mirror that is driven and rotated by the first polygon motor, the first polygon mirror being so formed as to have facets whose number is other than a multiple of a number of poles of the first polygon motor, such that a plurality of stable phase states can be obtained, the first polygon mirror forming an electrostatic latent image by scanning the first photoconductive drum; and
a second polygon mirror that is driven and rotated by the second polygon motor, the second polygon mirror forming an electrostatic latent image by scanning the second photoconductive drum,
the image forming apparatus forming an image by transferring toner images formed on surfaces of the first and second photoconductive drums, the toner images corresponding to the electrostatic latent images, with one toner image superimposed on another,
the method comprising:
a step (#12) of waiting for a predetermined time until speeds of the first and second polygon motors are stabilized;
a step (#13) of detecting scanning positions of the first and second polygon mirrors in a subscanning direction by detecting reference positions thereof in a main scanning direction after the speeds of the first and second polygon motors are stabilized;
a step (#14) of comparing phases of the scanning positions of the first and second polygon mirrors in the subscanning direction;
a step (#15) of detecting a presence or absence of phase shift by checking whether or not an amount of phase shift exceeds a predetermined amount based on results of phase comparison;
a step (#16) of retrieving from a storage, if the amount of phase shift in the subscanning direction is found to exceed the predetermined amount, a predetermined driving stop period corresponding to the detected amount of phase shift, the predetermined driving stop period during which a driving of the first polygon mirror is stopped; and
a step (#17) of stopping the driving of the first polygon mirror during the predetermined driving stop period thus retrieved, and then resuming the driving thereof in another stable phase state,
wherein the steps are repeatedly performed until the phase shift detected in step (#15) becomes acceptable.

18. The method of preventing color misregister in an image forming apparatus as claimed in claim 17, wherein
the first and second polygon motors are a same in a number of poles,
the first and second polygon mirrors are a same in a number of facets,
the number of facets of the first polygon mirror and the number of poles of the first polygon motor are relatively prime.

19. The method of preventing color misregister in an image forming apparatus as claimed in claim 17, wherein
the driving of the first polygon mirror is open-loop controlled during the predetermined driving stop period.
